(19) United States
(12) Patent Application Publication
(10) Pub. No.: US 2005/0073907 A1
(43) Pub. Date: Apr. 7, 2005

(54) Manual kneading machine

(75) Inventor: Mathias D'Estais, Cairon (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Heller

(21) Appl. No.: 10/960,734

(22) Filed: Oct. 7, 2004

(30) Foreign Application Priority Data
Oct. 7, 2003 (FR) 03/11731

(51) Int. Cl. B01F 7/02

(52) U.S. Cl. 366/99; 366/326.1

(57) ABSTRACT

A manual kneading machine including a container for receiving ingredients either placed directly in the container or introduced via an opening; and a crank fitted with at least one flexible paddle arranged in the container and being driven in rotation by a handle of the crank external to the container, wherein the paddle covers essentially the totality of the interior volume of the container when the paddle is rotated.

### RELATED APPLICATIONS

This application claims priority of French Patent Application No. 03/11731, filed Oct. 7, 2003.

### FIELD OF THE INVENTION

This invention pertains to the field of kneading machines and other devices to create an alimentary paste or mixture. The invention pertains more particularly to a manual kneading machine for children that allows them to make alimentary pastes, but also pastes that can be shaped or molded so that the children can play with them.

### BACKGROUND

Already known are recipes for creating pastes requiring manual processing steps. Thus, dry ingredients are mixed with each other and then liquids are added gradually. It is difficult to produce a good paste because the ingredients must be crushed for a very long period of time.

One inconvenience is that bits of paste or ingredients can stick between the fingers. Another inconvenience is that numerous bits of paste being processed or ingredient elements can drop and soil the work environment. These inconveniences are such that children are rarely allowed to make pastes. Thus, adults prepare the paste so that the children can then use it as a modeling paste, e.g., modeling dough, coatings, or for forming biscuits or any other type of cakes if the paste is edible.

Present developments of kneading machines and other devices for producing pastes have been for industrial or domestic devices intended to improve paste production and possibly its quality. In particular, kneading machines for professionals or private individuals use rigid paddles and automatic rotation of these paddles is often performed at very high speeds, between 1000 and 3000 rpm for home model kneading machines and on the order of 100 rpm with very large volumes for professional kneading machines. This is incompatible for use by children because of the hazardous nature of these devices.

An example of that type of device is disclosed in WO 95/08269. It includes a machine for continuously kneading paste constituted of a housing with an inlet for the paste to be kneaded plus other supplementary ingredients and an outlet for the kneaded paste, as well as a kneading assembly mounted in the housing on a practically horizontal axis. The kneading assembly has multiple axially elongated straight arms that extend radially from the axis, comprising passage openings and are arranged according to an angular spacing in relation to each other. A blade element adjacent to the entry side and in rotation along the kneading assembly exerts a downward force on the paste material to ensure optimal transport to the outlet of the machine as well as optimal kneading, even when the paste material has poor flow characteristics in its initial phase.

### SUMMARY OF THE INVENTION

This invention relates to a manual kneading machine including a container for receiving ingredients either placed directly in the container or introduced via an opening; and a crank fitted with at least one flexible paddle arranged in the container and being driven in rotation by a handle of the crank external to the container, wherein the paddle covers essentially the totality of the interior volume of the container when the paddle is rotated.

### BRIEF DESCRIPTION OF THE DRAWINGS

Enhanced comprehension of the invention will be obtained from the description presented below in a purely explanatory manner of a mode of implementation of the invention with reference to the attached drawings:

FIG. 1 is a perspective view of a mode of implementation of a manual kneading machine according to aspects of the invention;

FIG. 2 is an exploded perspective view of a group of constitutive elements of a manual kneading machine according to aspects the invention;

FIG. 3 is a perspective view of a variant of implementation of a manual kneading machine according to aspects of the invention in which the container rests on a base formed by four feet extending obliquely;

FIG. 4 is a sectional view of a particular container of a kneading machine according to aspects of the invention in which a protuberance directed toward the center of the container is presented; and

FIGS. 5a to 5c are views of paddles fitted to the manual kneading machine according to aspects of the invention.

### DETAILED DESCRIPTION

It will be appreciated that the following description is intended to refer to specific embodiments of the invention selected for illustration in the drawings and is not intended to define or limit the invention, other than in the appended claims.

This invention pertains to a manual kneading machine, intended in particular for children, comprising a container for receiving ingredients, e.g., water and/or flour, either placed directly in the container or introduced via an opening, a crank fitted with at least one flexible paddle, the paddle being arranged in the container and being driven in rotation by a handle of the crank external to the container, the paddle covering essentially the totality of the interior volume of the container when it is rotated. The container is advantageously mounted on a support.

According to one mode of execution of the invention, the support comprises four feet extending essentially obliquely from the support or the container. The assembly of the elements of the device, i.e., the container, its opening, the crank and the support, can advantageously be disassembled such that it is possible to disassemble the container into multiple parts, e.g., two hemispherical parts. The container advantageously has a spherical, ovoid, oliviform or flattened sphere shape.

According to one advantageous aspect of the invention, the container can comprise at least one interior protuberance, i.e., extending into the interior of the container. The support advantageously allows the axis of rotation of the paddle to be arranged in the vertical or horizontal position, or essentially inclined at about 15° in relation to the horizontal or essentially inclined at about 45° in relation to the horizontal.

According to various variants of the invention, the manual kneading machine comprises two paddles covering together or separately essentially the totality of the interior volume of the container when they are rotating or three or four paddles also covering together or separately essentially the totality of the interior of the container when they are rotating. According to another possibility, the manual kneading machine can comprise one, two, three or four helicoid paddles.

The opening of the container preferably comprises a seal. The manual kneading machine advantageously comprises a removable injection device. The injection device is preferably positioned above the container.

According to one possibility, the injection device will have a valve pushed by a spring to inject a liquid or a semiliquid into the container. The injection device may comprise a rod to force opening of the valve to distribute the liquid or semiliquid in the container.

According to another possibility, the injection device may comprise a slit elastomer membrane with the rod being used to deform the elastomer membrane to open it. The container is advantageously transparent.

According to another possibility, the kneading machine comprises a heating or cooling device at least partially surrounding the container. The device can include a double wall in which a hot or cool fluid circulates or simply rests.

According to another possibility, the device comprises an electric resistor or bulb. The support can advantageously comprise a base that notably has an essentially concave receptacle for accommodating the finished paste or any other element.

The base can advantageously comprise a multiplicity of attachment elements, e.g., simple housings, for attaching different accessories, e.g., for stamping the paste or shaping it.

As can be seen in the attached figures, the manual kneading machine according to aspects of the invention comprises a closed container 2 with a more or less spherical volume. The ingredients are placed directly into the container in the case in which the container is made of multiple parts or the ingredients are allowed to drop into the container 2 via its top opening 3.

The manual kneading machine 1 of the invention comprises a multiplicity of independent elements that can be mounted and/or attached to each other, such as a closed container 2 with an opening 3, a crank 4 comprising at least one paddle 5 and a handle 6, a base or support 7 on which the container 2 rests. As can be seen in FIG. 3, it can also be set up such that the opening of the container is equipped with a long tube 11 having an adequate diameter for the introduction of solid or liquid ingredients possibly with a reinforcement element surrounding this tube. In one mode of implementation of the invention, all of the elements comprising the manual kneading machine 1 are made of plastic. According to one possibility provided by the invention, only the base 7 is made of metal, in this case comprised of four feet extending obliquely and on which the container 2 rests.

The container 2 can have different forms and can also be constituted of multiple elements that can be attached to each other. In the example selected to illustrate the invention, the container 2 is composed of two parts 8, 9 which can be removed and attached to each other, e.g., by simple locking together of protuberances on the edges of one of the two parts 8 or 9 into grooves or holes present in coinciding positions on the edges of the other part 8 or 9. The container 2 may be transparent and made of a conventional plastic material.

The crank 4 consists of two parallel tubes, one of which is ideally longer than the other, connected to each other by a portion essentially perpendicular to the parallel tubes. The tube of shorter length comprises a handle 6 or simply a more ergonomic form suitable to be grasped by a child's hand. The tube of greater length comprises or is fitted with at least one flexible paddle 5, made of a plastic material such as an elastomer, attached to the section. This paddle 5 is located in a manner to extend essentially in the middle of this section, the end of this section being free such that when the crank 4 is introduced and attached in the container 2, this end extends beyond the container 2 to provide for the phenomenon of rotation of the paddle 5 in the container by means of the handle 6. The kneading machine 1 of the invention can have from one to four paddles 5 and paddle 5 can extend along a plane or be in a more complex form such as, e.g., a helicoid form as shown in FIG. 5c. The preferred form of the container 2 is an ovoid form but it can also be provided that the form is spherical, oliviform, in the form of a flattened sphere or the like. When the container 2 is made of a multiplicity of parts, this mode of implementation has the advantage of facilitating the incorporation of ingredients by direct opening of the parts constituting the container 2.

When the flexible paddle 5 rotates, it sweeps the entire interior surface of the container 2. When the liquid or semiliquid is introduced into the container 2, there is produced at the end of the rotation operation of the paddle(s) 5 a paste in spindle form which progresses by rolling on the surface of the container 2, which enables the paste to pick up all of the impurities and the remainder of the ingredients as the kneading operation advances and the interior of the container 2 is clean.

According to one aspect of the invention, one or two contractions in the volume can be provided in the container 2, i.e., extending toward the center of the container 2, to create a forced torsion of the paddle(s) or possibly a snapping of these paddle(s) during their rotation.

The axis of rotation of the paddle(s) 5 can moreover be offset from the horizontal to an incline of about 45° to the base, optionally resting on a support 10, e.g., by providing for some feet to be smaller than the others. It is also possible to provide for the container 2 to be placed substantially vertically and in this case the opening can be sealed in a manner to avoid spilling the ingredients contained within. In this mode of implementation, the end of the longer length of the crank 4 can be simply introduced into a housing functioning as a grip and the user then actuates the crank 4 and causes the paddle(s) 5 to rotate, and then subsequently pick up the resultant paste.

Each of the paddles can have a section such that it can cover a surface more or less equivalent to a hemisection of the container 2. When the kneading machine comprises multiple paddles 5, it is nevertheless possible to provide, in the case of two paddles, for one of the two paddles to have a relatively small surface smaller than a hemisection of the container while the other paddle has a surface that is still essentially equivalent to a hemisection of the container 2. It is also possible to provide that each of the paddles 5 covers a different surface of the hemisection of the container 2 but, in this case, the paddles 5 together form a surface at least equivalent to that of the hemisection of the container 2.

The injection of water, liquid or semiliquid is performed in a conventional manner after about ten rotations of the paddle(s) 5 in the dry state to thoroughly mix together the powders and other dry ingredients. The injection can be performed simply by opening the seal such as a cap of the opening of the container 2 and pouring in the desired dose of liquid or semiliquid.

The kneading machine 1 preferably comprises a removable dosing device inserted on a sleeve above the container, the injection or distribution of liquid or semiliquid taking place solely when one pushes on the removable dosing device. Injection is produced, e.g., by using a small dosing device the bottom of which is constituted of a valve pushed downwardly by a spring. A rod is provided in the axis of the sheath receiving the dosing device such that when one pushes on the dosing device, the rod forces the valve to open and distribute the liquids or semiliquids. In a variant, the “valve-spring” assembly can be replaced by a simple slit elastomer membrane.

Certain pastes can benefit from a temperature change, e.g., modeling pastes are produced in the hot state, and ices or sherbets are produced in the cold state. The manual kneading machine optionally comprises a heating and/or cooling device (not shown in the attached figures) to implement this characteristic. This can be implemented by surrounding the container 2 with a heating or cooling device, transmitting the heat or cold via the wall of the container which can be especially selected to enable such temperature exchanges. Heat can be provided by hot water poured or continuously flowing in a double wall. It can also be provided by the presence of a resistor or by a simple electric bulb emitting heat. Cold can be provided by water poured or continuously flowing in a double wall or by the presence of ice cubes or other cold-producing elements arranged in this double wall.

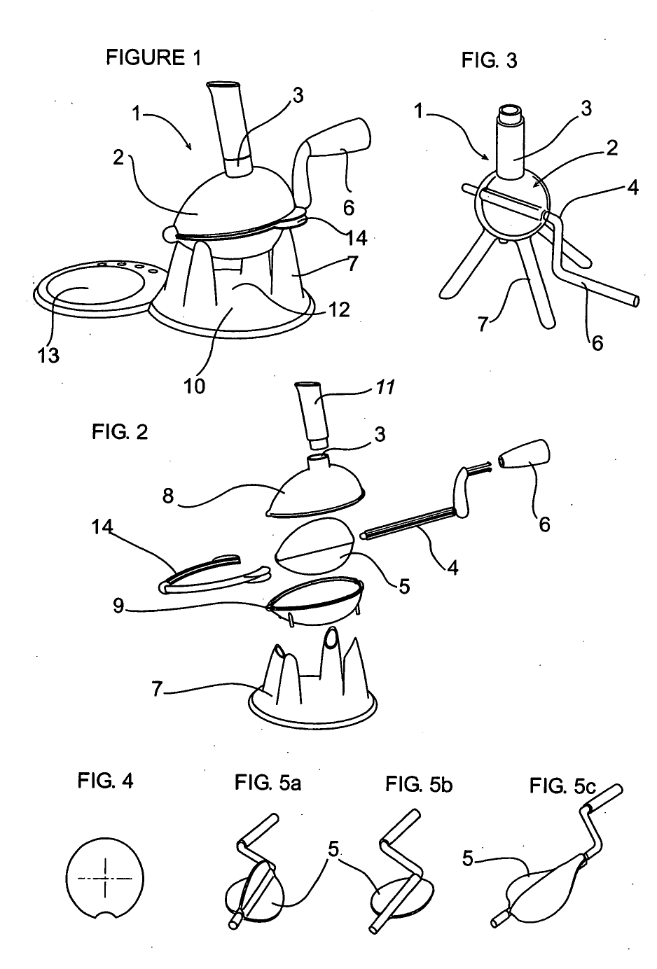

In the variant of the invention represented in FIG. 1, the support comprises a flat zone 12 between the support feet 7 of the container 2 to allow placement of the hand to stabilize the container 2 and its contents. The base 10 can also comprise a receptacle 13 for placing the resultant ball of paste. This receptacle can be an integral part of the base 10 or be removable and attachable to the base 10. This receptacle 13 can also accommodate accessories such as modeling tools, coloring agents and the like. The manual kneading machine 1 also comprises an attachment element 14 for attaching to each other the parts 8, 9 forming the container 2, for example, in the case in which these parts 8, 9 do not have intrinsic means for attachment to each other.

The kneading machine 1 can moreover comprise an element for generating vibrations (not shown in the figures) upon the rotation of the paddle(s), e.g., by the addition of a fixed blade coming into contact with a toothed wheel. The toothed wheel can be mounted on the crank 4, e.g., at the level of its section of greater length and supported on the exterior of the container 2 when the crank is in operating position. The fixed and optionally removable blade is attached on the exterior wall of the container 2 such that the blade comes into contact with the toothed wheel. It can of course be envisaged to provide a multiplicity of wheels as well as blades. This assembly can generate mechanical vibrations which have as a primary function the facilitating of the mixing of the ingredients present in or added to the container 2. Secondly, the vibrations produced by this assembly can create a distinctive noise indicating the rotation of the paddle(s) on the one hand for the safety of the user and on the other hand to enhance the recreational aspects of the device.

The invention was described above as an example. It is understood that the expert in the field could implement different variants of the invention without extending beyond the scope of the invention as set forth in the appended claims.

1. A manual kneading machine comprising:
a container for receiving ingredients either placed directly in the container or introduced via an opening; and
a crank fitted with at least one flexible paddle arranged in the container and being driven in rotation by a handle of the crank external to the container, wherein the paddle covers essentially the totality of the interior volume of the container when the paddle is rotated.

2. The kneading machine according to claim 1, wherein the container is mounted on a support.

3. The kneading machine according to claim 2, wherein the support comprises four feet extending essentially obliquely from the container.

4. The kneading machine according to claim 2, wherein the container, the opening, the crank and the support, can be disassembled and the container can be disassembled into two substantially hemispherical parts.

5. The kneading machine according to claim 1, wherein the container is a spherical, ovoid, oliviform or flattened sphere shape.

6. The kneading machine according to claim 1, wherein the container comprises at least one interior protuberance extending into an interior portion of the container.

7. The kneading machine according to claim 2, wherein the support allows an axis of rotation of the paddle to be arranged in a substantially vertical or substantially horizontal position, or essentially be inclined at about 15° in relation to the horizontal position or essentially inclined at about 45° in relation to the horizontal position.

8. The kneading machine according to claim 1, comprising two paddles covering together or separately substantially the totality of the interior volume of the container when the paddles are rotating.

9. The kneading machine according to claim 1, comprising three or four paddles covering together or separately substantially the totality of the interior of the container when the paddles are rotating.

10. The kneading machine according to claim 1, comprising one, two, three or four helicoid paddles.

11. The kneading machine according to claim 1, wherein the opening of the container has a seal.

12. The kneading machine according to claim 1, further comprising a removable injection device.

13. The kneading machine according to claim 12, wherein the injection device has a valve pushed by a spring for injecting a liquid or a semiliquid into the container.

14. The kneading machine according to claim 12, wherein the injection device is positioned above the container.

15. The kneading machine according to claim 13, wherein the injection device comprises a rod for forcing an opening of the valve to distribute the liquid or semiliquid in the container.

16. The kneading machine according to claim 14, wherein the injection device has a slit elastomer membrane with a rod to deform the elastomer membrane to allow its opening.

17. The kneading machine according to claim 1, wherein the container is transparent.

18. The kneading machine according to claim 1, further comprising a heating or cooling device at least partially surrounding the container.

19. The kneading machine according to claim 18, wherein the device comprises a double wall within which a hot or cold fluid is circulated or rests.

20. The kneading machine according to claim 18, wherein the device comprises an electric resistor or bulb.

21. The kneading machine according to claim 2, wherein the support comprises a base providing an essentially concave receptacle to receive finished paste or any other element.

22. The kneading machine according to claim 21, wherein the base comprises a multiplicity of attachment elements to attach different accessories.

23. A manual kneading machine comprising:
a container for receiving ingredients either placed directly in the container or introduced via an opening; and
a crank fitted with at least one flexible paddle arranged in the container and being driven in rotation by a handle of the crank external to the container, wherein the paddle covers essentially all of an interior surface of the container during paddle rotation.
